(19) United States
(12) Patent Application Publication
(10) Pub. No.: US 2008/0129759 A1
(43) Pub. Date: Jun. 5, 2008

(54) METHOD FOR PROCESSING IMAGE FOR MOBILE COMMUNICATION TERMINAL

(75) Inventors: Jin Young Jeon, Seoul (KR); Nho Kyung Hong, Seoul (KR); In Won Jong, Seoul (KR); Min Hwa Jung, Seoul (KR); Min Kyung Lee, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/942,475

(22) Filed: Nov. 19, 2007

(30) Foreign Application Priority Data
Dec. 4, 2006 (KR) 2006-0121662

(51) Int. Cl. G09G 5/00

(52) U.S. Cl. 345/667

(57) ABSTRACT

A method is provided for processing an image for a mobile communication terminal using a Graphical User Interface (GUI), in which zooming and panning are easily implemented through an input unit provided by the mobile communication terminal. A method for processing an image for a mobile communication terminal according to the present invention includes selecting and displaying a beginning point on a screen displayed with an image; and zooming the image using the beginning point as a center of the image according to location information of an end point corresponding to the beginning point by establishing and moving the end point connected to the beginning point.

### PRIORITY

This application claims priority under 35 U.S.C. §119(a) to an application entitled “METHOD FOR PROCESSING IMAGE FOR MOBILE COMMUNICATION TERMINAL” filed in the Korean Intellectual Property Office on Dec. 4, 2006 and assigned Serial No. 2006-0121662, the contents of which are incorporated herein by reference.

### BACKGROUND OF THE INVENTION

1. Field of the Invention

The present invention relates to a method for processing an image for a mobile communication terminal, and in particular to a method for processing an image for the mobile communication terminal to display the image by enlarging, reducing, or moving the image.

2. Description of the Related Art

It is possible to perform voice communication using a mobile communication terminal with few constraints of time and place due to development of mobile communication terminal technology. A user may be provided with, for example, character information, picture information, aN MP3 music file, and a game by adding functions to the mobile communication terminal, and receives the character information, the picture information, the MP3 music, and the game through a screen of the mobile communication terminal.

An image, such as a multimedia file, may often be processed through the mobile communication terminal. Particularly, zooming and panning are conveniently used as a method for processing the image. For example, zooming and panning are used to enlarge or reduce an image in a preview condition or an album of a camera, or to enlarge or reduce a character or data in a particular application, such as a file viewer.

A method of processing the image, such as zooming and panning, must be performed by selecting a key or an option item of the mobile communication terminal. A conventional mobile communication terminal additionally assigns the zooming function and the panning function to function assigned keys, if the mobile communication terminal enters a specific mode, for example, for the camera, the album, and the file viewer. Two keys are required to perform a zoom-in process and a zoom-out process, and a key is required to move an image up, down, left and right. Typically, two volume keys are used to perform a zooming function and a navigation key is used to perform a panning function. When a user uses both the zooming function and the panning function, it is inconvenient for the user to alternately use the volume keys and the navigation key when using both the zooming function and the panning function. It is also inconvenient for the user to press a key for an extended period to adjust the image up or down to a required size or to repeatedly press the key to adjust the image to the required size.

### SUMMARY OF THE INVENTION

The present invention has been made in an effort to solve the above problems, and provides a method that enables convenient use of a zooming function or a panning function.

The present invention further provides a method that removes an inconvenience of alternately using a plurality of keys for performing both the zooming function and the panning function.

The present invention further provides a method that enables the same key to be used for performing both the zooming function and the panning function.

In accordance with the present invention, a method for processing an image for a mobile communication terminal includes selecting and displaying a beginning point on a screen displayed with an image; and zooming the image using the beginning point as a center of the image according to location information of an end point corresponding to the beginning point by establishing and moving the end point connected to the beginning point.

In accordance with the present invention, a method for processing an image for a mobile communication terminal includes selecting a point on an image displayed on a screen as a beginning point using a pointer; moving the beginning point with the image to a preset point on the screen and displaying the beginning point with the image; and zooming the image using the beginning point as a center of the image according to location information of an end point of the pointer corresponding to the beginning point by moving the pointer from the beginning point to the end point.

In accordance with the present invention, a method for processing an image for a mobile communication terminal includes selecting a point on an image displayed on a touch screen as a beginning point by touching the point with a touch apparatus; moving the beginning point to a preset point on the touch screen and displaying the image by using the beginning point as a center of the image; and zooming the image using the beginning point as a center of the image according to location information of an end point corresponding to the beginning point of drag by establishing the end point with a dragging motion of the touch apparatus on the touch screen.

In accordance with the present invention, a method for processing an image for a mobile communication terminal includes selecting a point on an image displayed on a touch screen as a beginning point by touching the point with a touch apparatus; and zooming the image using the beginning point as a center of the image according to location information of an end point of a drag corresponding to the beginning point by dragging the touch screen using the beginning point as a start point while touching the beginning point.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating a configuration of a mobile communication terminal for using a method for processing an image according to the present invention;

FIG. 2 is a diagram illustrating a zoom vector of the mobile communication terminal of FIG. 1;

FIG. 3 is a diagram illustrating a zoom function of a zoom vector of the mobile communication terminal of FIG. 1;

FIG. 4 is a flowchart illustrating a method for processing an image for a mobile communication terminal according to a first exemplary embodiment of the present invention;

FIG. 5 is a flowchart illustrating a zooming process in the method for processing an image of FIG. 4;

FIG. 6 shows examples of display screens illustrating the method for processing an image of FIG. 4;

FIG. 7 shows further examples of display screens illustrating the method for processing an image of FIG. 4;

FIG. 8 is a flowchart illustrating a method for processing an image for a mobile communication terminal according to a second exemplary embodiment of the present invention; and

FIG. 9 shows examples of display screens illustrating the method for processing an image of FIG. 8.

### DETAILED DESCRIPTION OF EXEMPLARY EMBODIMENTS

The present invention will now be described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

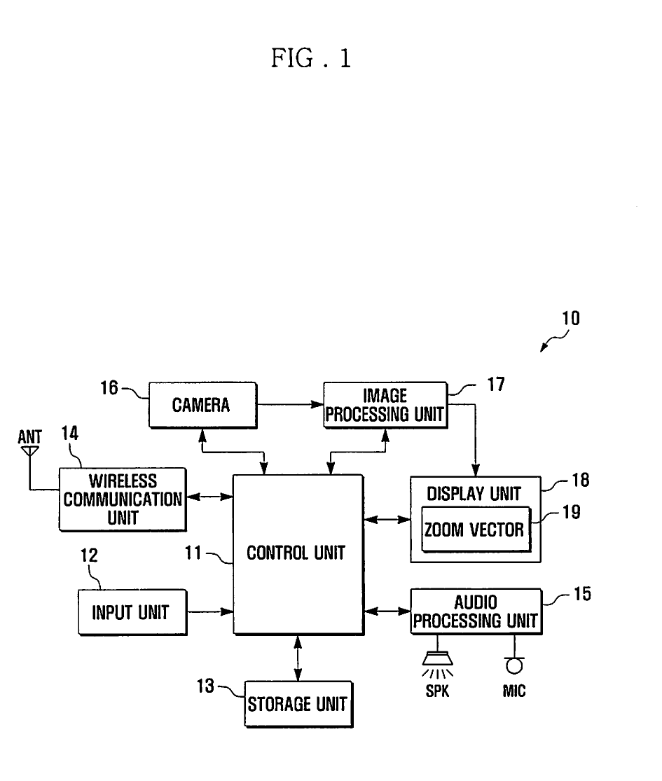

Referring to FIG. 1 through FIG. 3, a mobile communication terminal 10 includes a control unit 11, an input unit 12, a storage unit 13, a wireless communication unit 14, an audio processing unit 15, a camera 16, an image processing unit 17, and a display unit 18.

The control unit 11 performs overall control operation of the mobile communication terminal 10. The control unit 10 controls an image process, such as a zooming process and a panning process.

The input unit 12 provides a plurality of keys for a user input to the mobile communication terminal 10 and outputs key data to the control unit 11 corresponding to a key selected by a user. User commands input through the input unit 12 may be for controlling an image display or an image process.

The storage unit 13 stores required programs for controlling operation of the mobile communication terminal 10 and data resulting from execution of the required programs. The storage unit 13 also stores an image, programs for processing the image, and data resulting from execution of the programs. The image includes a preview image of the camera 16, a stored image in an album, and a displayed image that is displayed by executing a file viewer.

The wireless communication unit 14 transmits a radio frequency signal through an ANTenna (ANT) by modulating a signal output from the control unit 11 and upconverting to a frequency of the signal. The wireless communication unit 14 down-converts and demodulates a radio frequency signal received through the antenna ANT, and outputs the signal to the control unit 11.

The audio processing unit 15 converts an audio signal input through a MiCrophone (MIC) into digital format through control of the control unit 11, and demodulates audio data received by the wireless communication unit 14, and outputs the audio data through a SPeaKer (SPK).

The camera 16 produces image data by photographing an image. That is, the camera 16 produces the image data by photographing the image according to selection of a photographing mode through the input unit 12. The camera 16 includes an image sensor to transform an optical signal of a viewed object into an analog signal, and a signal-processing unit to transform the analog signal into a digital signal.

The image processing unit 17 processes image data output from the camera 16 to a format required for the display unit 18. The image-processing unit 17 edits the image data under the control of the control unit 11.

The display unit 18 displays function menus performed in the mobile communication terminal 10 and data stored in the storage unit 13, as image on a screen 18a. The display unit 18 displays a preview image output from the image-processing unit 17, an image stored in an album, and a document or data output using a file viewer.

Particularly, the control unit 11 processes an image through a Graphical User Interface (GUI) using a zoom vector 19, displayed on the screen 18a. Operation of the zoom vector 19 may be performed by a navigation key, a touch pad, or an optical sensor. The zoom vector 19 may be operated by a pointer 21.

The zoom vector 19 includes a beginning point 19a, a connect line 19b, and an end point 19c. The beginning point 19a is determined by a first selecting point using a pointer 21 on an image. The beginning point 19a is a base line of a zooming as well as a start point of a panning. The connect line 19b is a line connecting the beginning point 19a and a point at which the pointer is currently located (“current point”). The length of the connect line 19b is related to a zooming scale. The end point 19c is the point at which the pointer 21 is currently located.

The zoom vector 19 is displayed on an image of the screen 18a through operation of the pointer 21. The image is processed and displayed according to the displayed zoom vector 19.

If the pointer 21 selects a point on an image displayed on the screen 18a, the control unit 11 displays a beginning point 19a on the image. The control unit 11 displays the beginning point 19a on the selected point by the pointer 21, or displays the beginning point 19a by moving an image with a selected point by a pointer 21 to a preset point on the screen 18a. The latter case enables panning to be performed by selecting the beginning point 19a. The panning movement corresponds to a distance between a selected point by a pointer 21 and a preset point.

If the pointer 21 is moved from the beginning point 19a through the input unit 12, the control unit 11 displays the beginning point 19a, the connect line 19b, and the end point 19c on the screen 18a of the display unit 18. The control unit 11 processes an image by location information of the zoom vector 19, that is, by location information of the beginning point 19a and the end point 19c.

If the pointer 21 then selects the end point 19c through the input unit 12, the control unit 11 terminates the zooming and removes the zoom vector 19 from the screen 18a of the display unit 18.

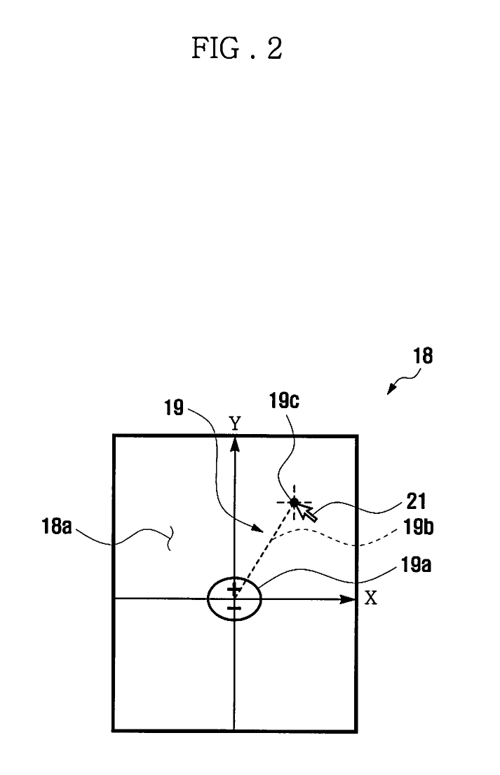

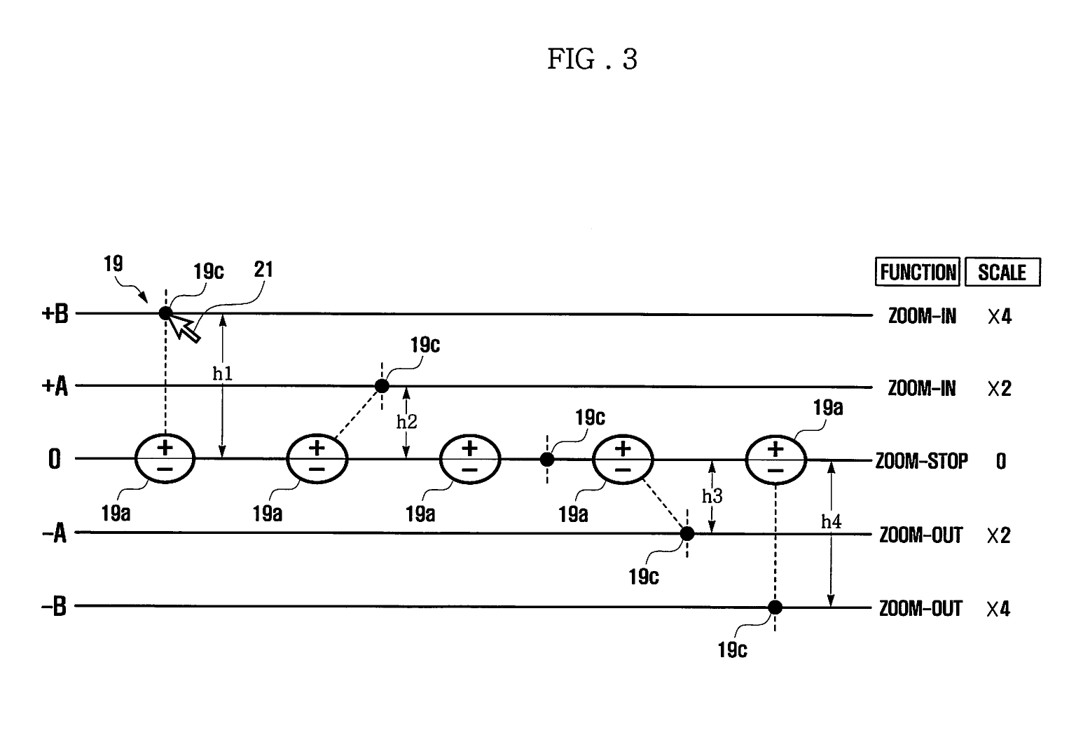

Location information of the zoom vector 19 and of the related zooming is shown in FIGS. 2 and 3. For convenience of description, as shown in FIG. 2, the beginning point 19a is assumed to be located at the center point of a displayed image, at the intersection point of an X-axis and a Y-axis. A property of the zoom vector 19 is determined by coordinates representing location information for the beginning point 19a and the end point 19c.

As shown in FIG. 3, if the end point 19c of a movement from the beginning point 19a is located above the beginning point 19a, that is, in an upper-right quadrant of the screen 18a or an upper-left quadrant of the screen 18a, a zoom-in process is performed. A zoom-in enlargement is in direct proportion to a length of the zoom vector 19. According to an exemplary embodiment of the present invention, a zoom-in enlargement is in direct proportion to a length of the zoom vector 19 in the direction of the Y-axis. If the end point 19c is located on a +B line shown in FIG. 3, the zoom-in is performed to four times a predetermined enlargement of a starting image size. If the end point 19c is located on a +A line shown in FIG. 3, the zoom-in is performed to twice the predetermined enlargement of a starting image size.

If the end point 19c of a movement from the beginning point 19a is located on the X-axis, a zoom-stop is performed. That is, the zoom-stop is performed when the zoom vector 19 is located on the X-axis.

If the end point 19c of a movement from the beginning point 19a is located in a lower-right quadrant or a lower-left quadrant of the screen 18a, a zoom-out is performed. The zoom-out reduction is in direct proportion to the length of the zoom vector 19 in the direction of the Y-axis. If the end point 19c is located on a −A line shown in FIG. 3, the zoom-out is performed up to twice a predetermined reduction of a starting image size. If the end point 19c is located on a −B line shown in FIG. 3, the zoom-out is performed up to four times the predetermined reduction of a starting image size. The end point 19c is freely moved in the XY plane according to a movement of the pointer 21. The zoom-in, the zoom-stop, and the zoom-out may be consecutively and alternately performed. For example, if a movement of the pointer 21 is performed from the +B line to the −B line, the zooming is consecutively performed at four times the predetermined enlargement for the zoom-in, twice the predetermined enlargement for the zoom-in, the zoom-stop, twice the predetermined reduction for the zoom-out, and four times the predetermined reduction for the zoom-out.

The beginning point 19a is displayed at the center of the X-axis and Y-axis in an ellipse format for a user to easily distinguish the zoom-in, the zoom-stop and the zoom-out. As shown in FIG. 2, the zoom-in function is displayed in an ellipse inside of an upper-right quadrant and of an upper-left quadrant of the screen 18a as a “+” symbol. The zoom-out function is displayed in the ellipse inside of a lower-right quadrant and of a lower-left quadrant of the screen 18a as a “−” symbol. The zoom vector 19 including the beginning point 19a may be displayed in other formats. According to this exemplary embodiment of the present invention, when the end point 19c is located above the beginning point 19a, the zoom-in is performed. When the end point 19c is located horizontally level with the beginning point 19a, the zoom-stop is performed. When the end point 19c is located below the beginning point 19a, the zoom-out is performed. However, the present invention is not limited thereto. For example, in another embodiment, when the end point 19c is located above the beginning point 19a, the zoom-out is performed. When the end point 19c is located horizontally level with the beginning point 19a, the zoom-stop is performed. When the end point 19c is located below the beginning point 19a, the zoom-in is performed.

According to this exemplary embodiment of the present invention, the zooming scale is in direct proportion to the length of the zoom vector 19 in the direction of the Y-axis, however, the present invention is not limited thereto. In other embodiments, the zooming scale may be described in direct proportion to the length of the zoom vector 19, that is, the distance between the beginning point 19a and the end point 19c. An X-axis or a Y-axis may be established as a base line of the zooming. The zooming enlargement may be described as being in direct proportion to the length of the zoom vector 19 in the direction of the X-axis, or as being in direct proportion to the length of the zoom vector 19.

According to the present invention, an image is processed by a pointer 21 displayed on the screen 18a. However, the display unit 18 may process the image through touching of a touch screen by a user. The beginning point 19a may be selected through touching a touch apparatus and the zooming may be performed through dragging the touched point on the touch screen. The touch screen performs as a display unit 18 and an input unit 12.

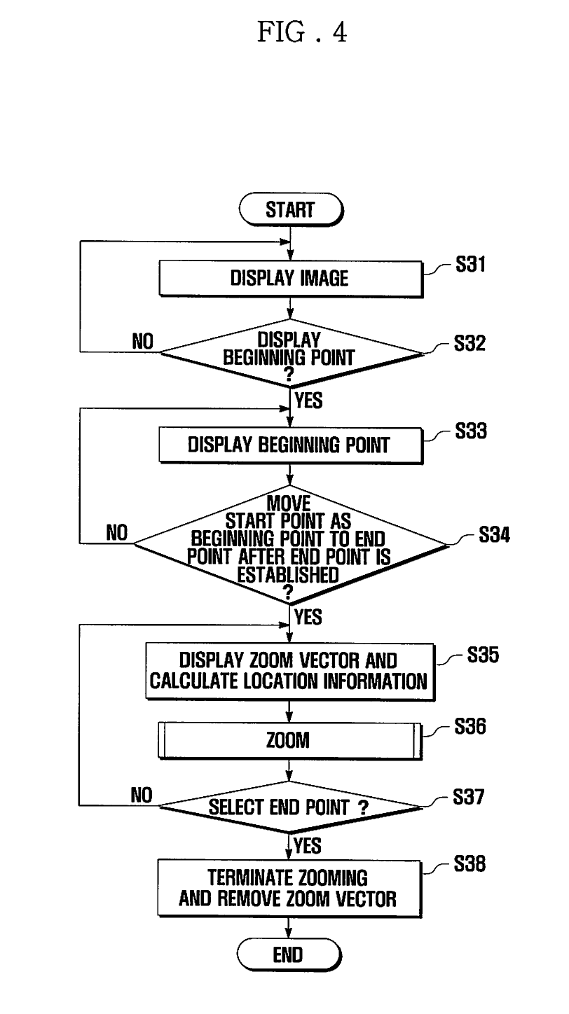

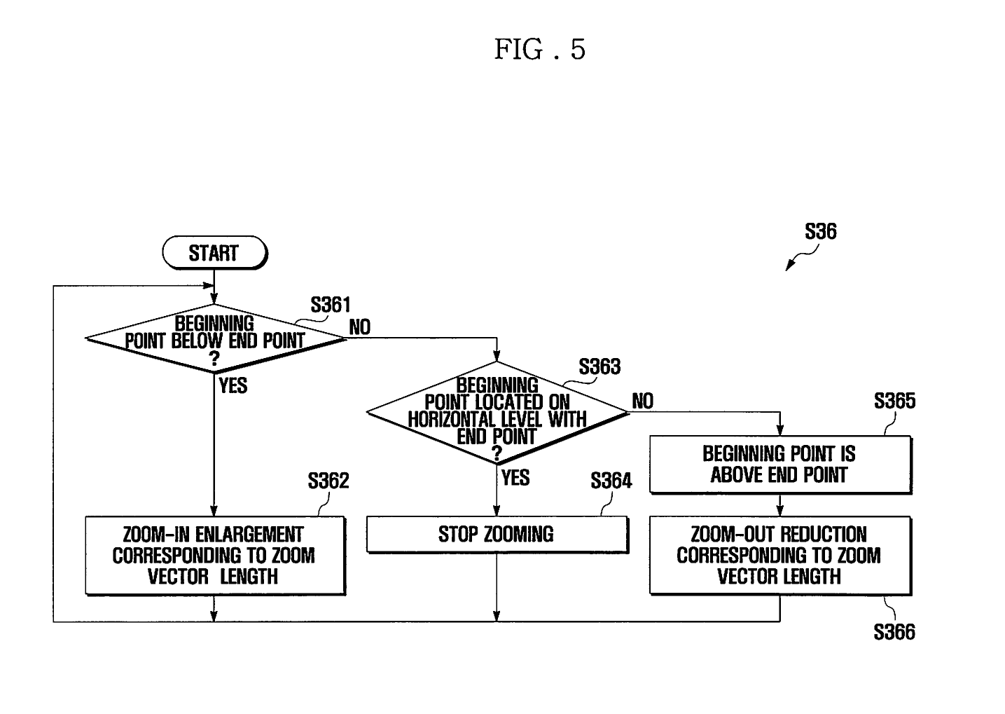

FIG. 4 is a flowchart illustrating a method for processing an image for a mobile communication terminal according to a first exemplary embodiment of the present invention. FIG. 5 is a flowchart illustrating a zooming process in the method for processing an image of FIG. 4.

Referring to FIG. 4, firstly, the image is displayed on the screen 18a of the display unit 18, in Step S31. The control unit 11 displays the image on the screen 18a according to a user key input requesting to display the image.

The control unit 11 determines whether a point of the image is selected as a beginning point 19a on the screen 18a, in Step S32. If a beginning point 19a is not selected, the control unit 11 continues to display the current image. If a beginning point 19a is selected, the control unit 11 displays the beginning point 19a on the image, in Step S33.

The control unit 11 determines whether an end point 19c is moved starting from the beginning point 19a after establishing the end point, in Step S34. If an end point 19c is not moved, the control unit 11 continues to display the beginning point 19a. If an end point 19c is moved, the control unit 11 displays a zoom vector 19 on the screen 18a and calculates location information of the beginning point 19a and the end point 19c as location information of the zoom vector 19, in Step S35. Because the beginning point 19a is the point of origin of an X-axis and a Y-axis, location information of the zoom vector 19 is an X-Y coordinate of the end point 19c. The control unit 11 determines whether the end point 19c of a movement from the beginning point 19a is located above the beginning point 19a, below the beginning point 19a, or horizontally level with the beginning point 19a, through the coordinate of the end point 19c. The control unit 11 calculates the length of the zoom vector 19 in the direction of the Y-axis through the coordinate of the end point 19c. The length of the zoom vector 19 in the direction of the Y-axis corresponds to the distance in the direction of the Y-axis from the coordinate of the end point 19c to the beginning point 19a.

The control unit 11 performs the zooming process using the beginning point 19a as a center according to the calculated location information of the zoom vector 19, in Step S36.

The control unit 11 determines whether the end point 19c is selected, in Step S37. If the end point 19c is not selected, the control unit 11 repeats the processes of Steps S35 and S36. If the end point 19c is selected, the control unit 11 terminates the zooming, in Step S38. The control unit 11 removes the zoom vector 19 from the screen 18a.

Referring to FIG. 5, the zooming process at Step S36 is described in detail as follows. The end point 19c of a movement from the beginning point 19a is determined based on the location information for the zoom vector 19. If the end point 19c is located above the beginning point 19a, in Step S361, the control unit 11 performs a zoom-in process at a zoom enlargement corresponding to the calculated length of the zoom vector 19 in the direction of the Y-axis, in Step S362.

If the end point 19c is located horizontally level with the beginning point 19a, in Step S363, the control unit 11 stops the zooming process, in Step S364.

If the end point 19c is located below the beginning point 19a, in Step S365, the control unit 11 performs a zoom-out process at a zoom reduction corresponding to the calculated length of the zoom vector 19 in the direction of the Y-axis, in Step S366. As described before, the zoom vector 19 is embodied by a Graphical User Interface (GUI) using a pointer 21 or by a GUI using a touch screen.

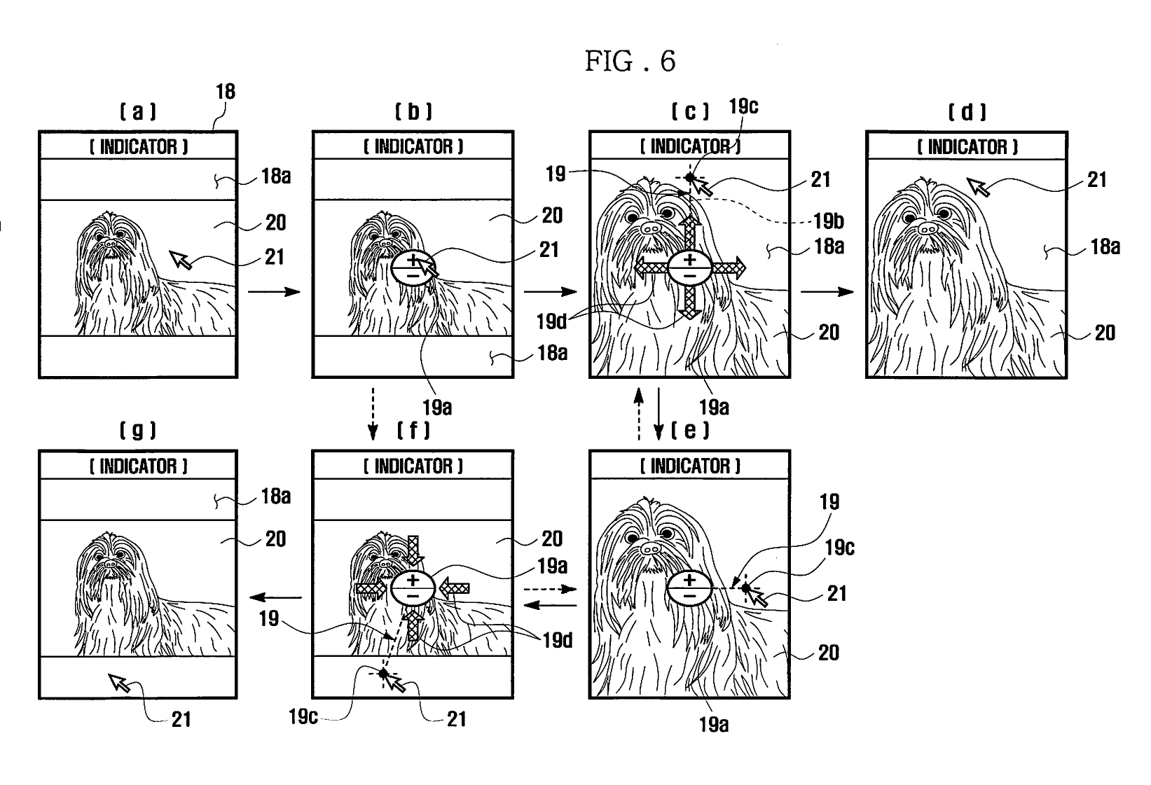

FIG. 6 shows examples of display screens illustrating a zooming process in the method for processing an image of FIG. 4, using a pointer 21. Examples of the pointer 21 operated by an optical sensor are shown.

As shown in FIG. 6A, the control unit 11 displays an image 20 on the screen 18a of the display unit 18 according to a key input of a user and displays the pointer 21 on the image 20. The pointer 21 moves the optical sensor corresponding to a direction, speed, and distance of a drag on the image 20.

As shown in FIG. 6B, the pointer 21 is located on a selected location to be a beginning point 19a. If the location of the pointer 21 is selected by a key input, the control unit 11 displays the point as the beginning point 19a.

As shown in FIG. 6C, the optical sensor is moved according to the movement of the pointer 21 to the beginning point 19a, and the control unit 11 begins a zoom-in process for the image 20 using the beginning point 19a as a center of the image. As the pointer 21 is moved, the pointer 21 indicates the end point 19c of the zoom vector 19 and the control unit 11 displays the zoom vector 19 on the screen 18a. The control unit 11 performs the zoom-in process for the image 20 at a zoom enlargement corresponding to the length of the zoom vector 19 in the direction of the Y-axis. The zoom-in process is consecutively performed corresponding to the length of the zoom vector 19 in the direction of the Y-axis while the pointer 21 is moved above the beginning point 19a.

The zoom-in process is indicated by displaying arrows centered on the beginning point 19a and pointing outwards away from the beginning point 19a in the direction of the X-axis and Y-axis.

As shown in FIG. 6D, if a location of the pointer 21 is selected as the end point 19c through a key input while performing the zoom-in process, the control unit 11 terminates the zoom-in process. The control unit 11 removes the zoom vector 19 from the screen 18a and displays only the pointer 21 on the image 20.

As shown in FIG. 6E, if the end point 19c located above the beginning point 19a is dragged by the optical sensor to be horizontally level with the beginning point 19a, the control unit 11 stops the zooming process.

As shown in FIG. 6F, if the end point 19c dragged by the optical sensor is moved to below the beginning point 19a, the control unit 11 performs a zoom-out process. The control unit 11 performs the zoom-out at a zoom reduction corresponding to the length of the zoom vector 19 in the direction of the Y-axis. The zoom-out process is consecutively performed corresponding to the length of the zoom vector 19 in the direction of the Y-axis while the pointer 21 is moved below the beginning point 19a.

The zoom-out process is indicated by displaying arrows centered on the beginning point 19a and pointing inwards towards the beginning point 19a in the direction of the X-axis and Y-axis.

As shown in FIG. 6G, if the end point 19c is selected by a key input at a current location of the pointer 21, the control unit 11 terminates the zoom-out. The control unit 11 removes the zoom vector 19 from the screen 18a and displays only the pointer 21 on the image 20.

In the process sequence herein described with reference to FIG. 6, after the pointer 21 selects the beginning point 19a (FIG. 6B), processes of zoom-in (FIG. 6C), zoom-stop (FIG. 6E), and zoom-out (FIG. 6F) are sequentially performed. However, after the pointer 21 selects the beginning point 19a (FIG. 6B), processes of zoom-out (FIG. 6F), zoom-stop (FIG. 6E), and zoom-in (FIG. 6C) may also be sequentially performed.

Examples of a pointer 21 operated by an optical sensor are shown; however, the pointer 21 may also be operated by a touch pad or a navigation key. Movement of the end point 19c of the zoom vector 19 using a touch pad is performed by a dragging movement, the same as with the optical sensor. Movement of the end point 19c of the zoom vector 19 using a navigation key is performed in a stepwise manner by repeated pressing of a key.

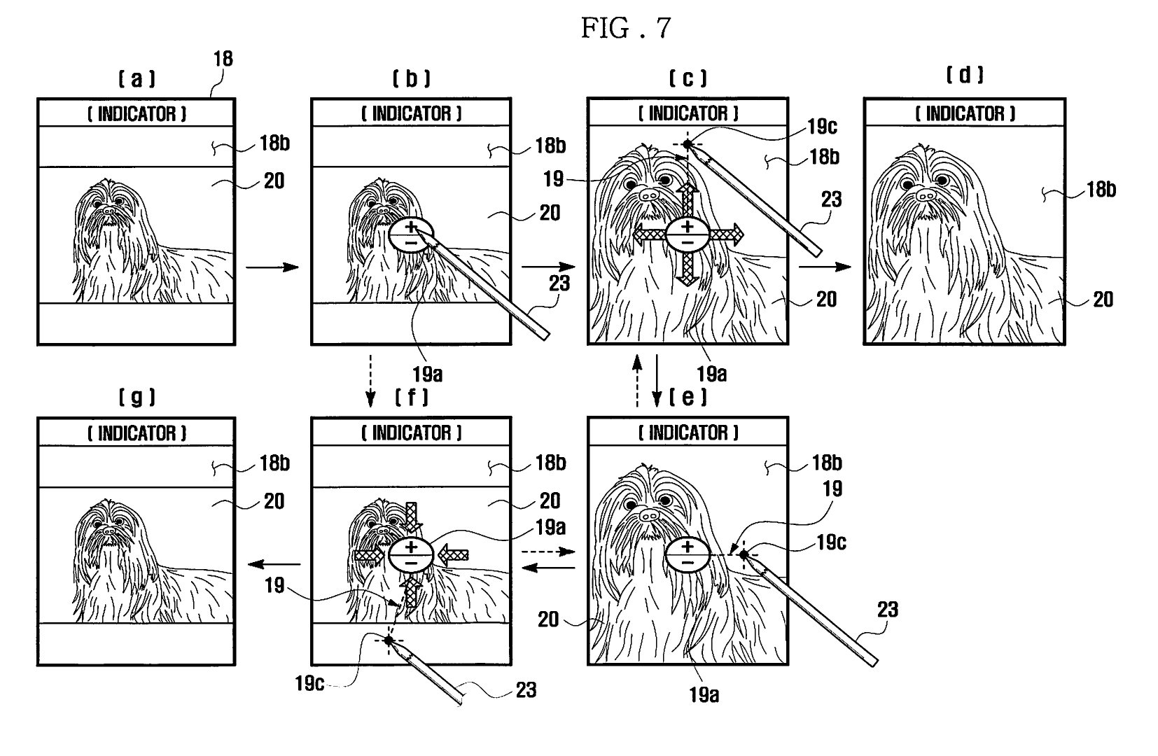

FIG. 7 shows further examples of display screens illustrating the method for processing an image of FIG. 4, using a touch-screen 18b as a screen of the display unit 18.

As shown in FIG. 7A, the control unit 11 displays the image by touching through a key input or a touch apparatus on the touch screen 18b.

As shown in FIG. 7B, if a user touches a selected point as a beginning point 19a with a touch apparatus 23 on a touch screen 18b, the control unit 11 displays the beginning point 19a at the touch point.

If a user drags from the beginning point 19a as a start point with the touch apparatus 23, the zooming process is performed. Touching to select the beginning point 19a and dragging to perform the zooming process may be performed consecutively or independently. When the zooming process is consecutively performed, the zooming process is performed by dragging without detachment of the touch apparatus 23 from the touch screen 18b since the beginning point 19a is selected with the touch apparatus 23. When the zooming process is independently performed, the beginning point 19a is selected by detaching the touch apparatus 23 from the touch screen 18b after touching the touch screen 18b with the touch apparatus 23. The zooming process is continuously performed by dragging from the beginning point 19a as a start point.

As shown in FIG. 7C, if a drag from the beginning point 19a is upwards, the control unit 11 performs the zoom-in process of the image 20 centered on the beginning point 19a. The control unit 11 indicates the end point 19c with the touch apparatus 23 touched on the touch screen 18b and displays the zoom vector 19 on the touch screen 18b. The control unit 11 performs the zoom-in process for the image 20 at a zoom enlargement corresponding to the length of the zoom vector 19 in the direction of the Y-axis. The zoom-in process is consecutively performed corresponding to the length of the zoom vector 19 in the direction of the Y-axis while the end point 19c is located above the beginning point 19a.

As shown in FIG. 7D, if the touch apparatus 23 is detached from the touch screen 18b while performing the zoom-in process, the control unit 11 terminates the zoom-in process. The control unit 11 removes the zoom vector 19 from the touch-screen 18b.

As shown in FIG. 7E, if the end point 19c is moved to be horizontally level with the beginning point 19a by dragging the touch apparatus 23, the control unit 11 stops the zooming process.

As shown in FIG. 7F, if the end point 19c is moved below the beginning point 19a by dragging the touch apparatus 23, the control unit 11 performs a zoom-out process. The control unit 11 performs the zoom-out process of the image 20 at a zoom reduction corresponding to the length of the zoom vector 19 in the direction of the Y-axis. The consecutive zoom-out process is performed while the end point 19c, touched by the touch apparatus 23, is located below the beginning point 19a.

As shown in FIG. 7G, if the touch apparatus 23 is detached from the touch screen 18b, the control unit 11 terminates the zoom-out process. The control unit 11 removes the zoom vector 19 from the touch screen 18b.

Although, in this exemplary embodiment, the beginning point 19a is selected as a start point of a drag, the present invention is not limited thereto. For example, the starting point for the drag may be not only a beginning point, but also may be a point on the touch screen. The zooming is performed by a zoom vector established by the starting point and the end point.

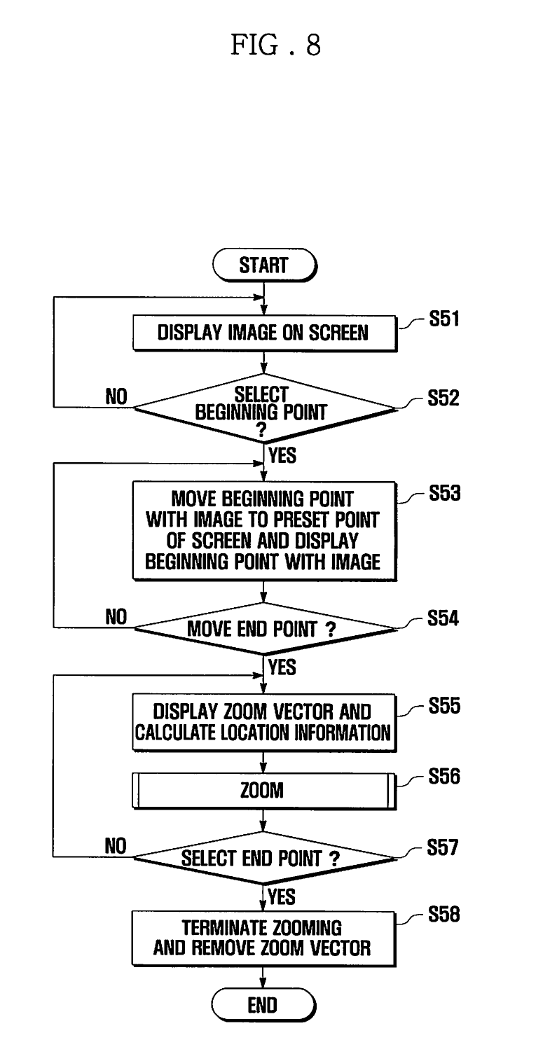

The method for processing an image according to the first exemplary embodiment describes a process of displaying a beginning point on a selected point on a screen. FIG. 8 is a flowchart illustrating a method for processing an image for a mobile communication terminal according to a second exemplary embodiment of the present invention, in which a panning process is performed by selecting a point on a screen.

Referring to FIG. 8, firstly, the image is displayed on the screen 18a of the display unit 18, in Step S51.

The control unit 11 determines whether a point of the image is selected as a beginning point 19a on the screen 18a, in Step S52. If a beginning point 19a is not selected, the control unit 11 continues to display the current image. If a beginning point 19a is selected, the control unit 11 moves the beginning point 19a with the image to a preset point on the screen 18a, and displays the beginning point 19a with the image, in Step S53. The control unit 11 thereby performs a panning process. The preset point may be a center of the screen 18a or a center of an image displayed on the screen 18a.

The panning process moves the image on the screen 18a according to the length and direction of movement of the selected point to the preset point while displaying the image on the screen 18a.

Steps S54 through S58 in the method of processing an image according to the second exemplary embodiment are performed in the same manner as steps S34 through S38, respectively, in the method of processing an image according to the first exemplary embodiment, and therefore a detailed description thereof is omitted.

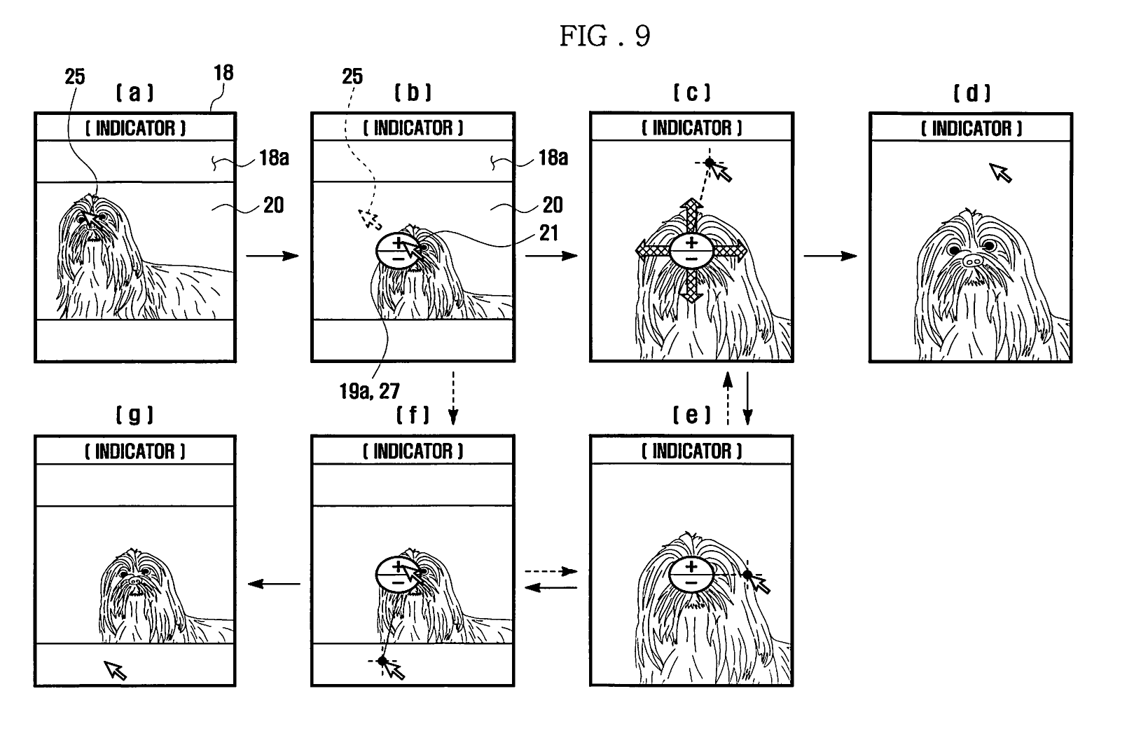

FIG. 9 shows examples of display screens illustrating the method for processing an image according to the second exemplary embodiment of the present invention. Operation of the zoom vector 19 by a pointer 21 is described.

As shown in FIG. 9A, the control unit 11 displays an image 20 on the screen 18a of the display unit 18 according to a key input of a user and displays the pointer 21 on the image 20.

As shown in FIG. 9B, the pointer 21 is located on the point to be selected as a beginning point 19a. If the location of the pointer 21 is selected through a key input, the control unit 11 moves the image 20 to a point 25 selected by the pointer 21, which is a preset point 27, on a screen 18a and displays the preset point 27 with a beginning point 19a. The preset point 27 may be a center of the image, and the control unit 11 displays the beginning point 19a and the pointer 21 on the preset point 27.

The processes of zoom-in, zoom-stop, zoom-out, and selection of an end point of the method for processing an image according to the second exemplary embodiment, illustrated in FIGS. 9C through 9G, are performed in the same manner as those of the first exemplary embodiment, illustrated in FIGS. 6C through 6G, respectively, and therefore a detailed description of the display screen examples of FIGS. 9C through 9G is omitted.

According to an exemplary embodiment of the present invention, zooming and panning may be implemented through a Graphic User Interface (GUI) using a zoom vector. Therefore, it is convenient for a user to perform the zooming and the panning by an input unit provided in a mobile communication terminal.

Because the zooming and the panning may be used together due to operation of a zoom vector used by a navigation key, a touch pad, an optical sensor, or a touch screen, as an input unit provided in the mobile communication terminal, the zooming function and the panning function may be improved by reducing the usage of keys. That is, this invention removes an inconvenience of alternately using a plurality of keys to use the zooming function and the panning function together in a conventional method.

Because the end point on the screen is freely moved by using the beginning point as a center for the zoom vector, the zoom-in, the zoom-stop, and the zoom-out may be performed consecutively or alternately.

Although exemplary embodiments of the present invention have been described in detail hereinabove, it should be understood that many variations and modifications of the basic inventive concepts herein described, which may appear to those skilled in the present art, will still fall within the spirit and scope of the present invention as defined in the appended claims.

What is claimed is:

1. A method for processing an image for a mobile communication terminal, comprising:
selecting and displaying a beginning point on a screen displayed with an image; and
zooming the image using the beginning point as a center of the image according to location information of an end point corresponding to the beginning point by establishing and moving the end point connected to the beginning point.

2. The method of claim 1, wherein in selecting and displaying the beginning point, the image is displayed using the beginning point as the center of the image through moving the beginning point to a preset point of the screen.

3. The method of claim 2, wherein the preset point is one of a center of the screen and the center of the image displayed on the screen.

4. The method of claim 1, wherein in zooming the image using the beginning point, a zooming scale is in direct proportion to a distance corresponding to locations of the beginning point and the end point.

5. The method of claim 4, wherein zooming the image using the beginning point comprises:
if the end point is located below a horizontal axis extending through the beginning point, performing a zoom-out for the image using the beginning point as the center of the image;
if the end point is located above the horizontal axis extending through the beginning point, performing a zoom-in for the image using the beginning point as the center of the image; and
if the end point is located on the horizontal axis extending through the beginning point, performing a zoom-stop for the image.

6. The method of claim 4, wherein zooming the image using the beginning point comprises:
if the end point is located below a horizontal axis extending through the beginning point, performing a zoom-in for the image using the beginning point as the center of the image;
if the end point is located above the horizontal axis extending through the beginning point, performing a zoom-out for the image using the beginning point as the center of the image; and
if the end point is located on the horizontal axis extending through the beginning point, performing a zoom-stop for the image.

7. The method of claim 5, wherein the zoom-in, the zoom-stop, and the zoom-out are performed consecutively and alternately.

8. The method of claim 6, wherein the zoom-in, the zoom-stop, and the zoom-out are performed consecutively and alternately.

9. The method of claim 1, further comprising:
terminating the zooming of the image by selecting the end point.

10. The method of claim 9, wherein the beginning point and the end point are removed from the screen by the selecting the end point.

11. The method of claim 9, wherein the beginning point and the end point are selected by a pointer displayed on the image.

12. The method of claim 11, wherein in zooming the image using the beginning point, the pointer indicating the end point in the zooming is moved by one of a touch pad, an optical sensor, and a navigation key.

13. The method of claim 9, wherein the screen is a touch screen, and wherein:
selecting the beginning point for displaying and selecting the end point for terminating are performed by touching the touch screen; and
movement of the end point in the zooming is performed through dragging.

14. A method for processing an image for a mobile communication terminal, comprising:
selecting a point on an image displayed on a screen as a beginning point using a pointer;
moving the beginning point with the image to a preset point on the screen and displaying the beginning point with the image; and
zooming the image using the beginning point as a center of the image according to location information of an end point of the pointer corresponding to the beginning point by moving the pointer from the beginning point to the end point.

15. The method of claim 14, further comprising:
terminating the zooming of the image by selecting the end point.

16. The method of claim 15, wherein in zooming the image using the beginning point, a zooming scale is in direct proportion to a distance corresponding to locations of the beginning point and the end point.

17. The method of claim 16, wherein the zooming, comprises:
if the end point is located above or below a horizontal axis extending through the beginning point, performing the zooming; and
if the end point is located on the horizontal axis extending through the beginning point, terminating the zooming.

18. A method for processing an image for a mobile communication terminal, comprising:
selecting a point on an image displayed on a touch screen as a beginning point by touching the point with a touch apparatus;
moving the beginning point to a preset point on the touch screen and displaying the image by using the beginning point as a center of the image; and
zooming the image using the beginning point as the center of the image according to location information of an end point corresponding to a beginning point of a drag by establishing the end point with a dragging motion of the touch apparatus on the touch screen.

19. The method of claim 18, further comprising:
terminating the zooming by detaching the dragging touch apparatus from the touch screen.

20. The method of claim 19, wherein a start point of the drag is a beginning point.

21. The method of claim 20, wherein in zooming the image using the beginning point, a zooming scale is in direct proportion to a distance between the start point of the drag and the end point of the drag.

22. A method for processing an image for a mobile communication terminal, comprising:
selecting a point on an image displayed on a touch screen as a beginning point by touching the point with a touch apparatus; and
zooming the image using the beginning point as a center of the image according to location information of an end point of a drag corresponding to the beginning point by dragging the touch screen using the beginning point as a start point while touching the beginning point.
